(19) United States
(12) Patent Application Publication
(10) Pub. No.: US 2024/0405332 A1
(43) Pub. Date: Dec. 5, 2024

(54) HOLLOW PRISMATIC AND CYLINDRICAL BATTERY CELLS, METHOD FOR MANUFACTURING, AND BATTERY HEAT EXCHANGE SYSTEM

(71) Applicant: GM GLOBAL TECHNOLOGY OPERATIONS LLC, Detroit, MI (US)

(72) Inventors: Hui-ping WANG, Troy, MI (US); Lu HUANG, Troy, MI (US); Fang DAI, Troy, MI (US); Guangze LI, Novi, MI (US); Mei CAI, Bloomfield Hills, MI (US)

(21) Appl. No.: 18/325,515

(22) Filed: May 30, 2023

(51) Int. Cl. H01M 50/209; H01M 10/04; H01M 10/6556; H01M 50/103; H01M 50/107; H01M 50/213

(52) U.S. Cl. CPC H01M 50/209; H01M 10/0431; H01M 10/6556; H01M 50/103; H01M 50/107; H01M 50/213

(57) ABSTRACT

A battery system includes N hollow battery cells, each including an enclosure including a top surface, a bottom surface, and a side wall; a hollow center tube including a side wall and a cavity enclosed by the side wall, and a roll including electrode and separator layers arranged between an outer surface of the hollow center tube and the enclosure. The hollow center tube passes through at least one of the top surface and the bottom surface of the enclosure. A battery heat exchange system includes a first fluid channel including N ports configured to at least one of supply fluid to and receive fluid from at least one end of the hollow center tube of the N hollow battery cells.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to hollow battery cells and heat exchange systems for hollow battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A battery system includes N hollow battery cells, each including an enclosure including a top surface, a bottom surface, and a side wall; a hollow center tube including a side wall and a cavity enclosed by the side wall, and a roll including electrode and separator layers arranged between an outer surface of the hollow center tube and the enclosure. The hollow center tube passes through at least one of the top surface and the bottom surface of the enclosure. A battery heat exchange system includes a first fluid channel including N ports configured to at least one of supply fluid to and receive fluid from at least one end of the hollow center tube of the N hollow battery cells.

In other features, the enclosure has a cylindrical shape and the hollow center tube has a circular cross section.

In other features, the hollow center tube passes through the top surface and the bottom surface of the enclosure. The battery heat exchange system includes a second fluid channel configured to at least one of supply fluid to and receive fluid from an opposite end of the hollow center tube of the N hollow battery cells. At least one of the top surface and the bottom surface comprises a cap attached to the side walls of the enclosure and the hollow center tube.

In other features, the enclosure has a prismatic shape, and the hollow center tube has a rounded rectangular cross section. The hollow center tube passes through the top surface and the bottom surface of the enclosure. The battery heat exchange system includes a second fluid channel configured to at least one of supply fluid to and receive fluid from an opposite end of the hollow center tube of the N hollow battery cells. The first fluid channel includes a plurality of partitions to create a serpentine vertical path in the hollow center tube. The first fluid channel includes a plurality of partitions to create a serpentine horizontal path in the hollow center tube.

In other features, the N ports include N walls extending transverse to the first fluid channel and including threads on an outer surface thereof. An inner surface of the side wall of the hollow center tube of the N hollow battery cells includes threads. The first fluid channel includes N partitions in the N ports, respectively. Each of the N hollow battery cells includes a partition arranged in the hollow center tube. A second fluid channel is arranged adjacent and in contact with the first fluid channel, wherein fluid flows in a first direction through the first fluid channel and in a second direction through the second fluid channel. The first fluid channel extends in a serpentine path upwardly and downwardly through the hollow center tubes of adjacent ones of the N hollow battery cells.

In other features, the N ports include N walls extending transverse to the first fluid channel. The N walls are press fit into an inner surface of the side wall of the hollow center tube of the N hollow battery cells.

A battery system includes N hollow cylindrical battery cells, each including an enclosure including a top surface, a bottom surface, and side walls, a hollow center tube including a side wall defining a cavity and having a circular cross section, and a roll including electrode and separator layers arranged between an outer surface of the hollow center tube and the enclosure. The hollow center tube passes through at least one of the top surface and the bottom surface of the enclosure. A battery heat exchange system includes a first fluid channel including N ports configured to at least one of supply fluid to and receive fluid from at least one end of the hollow center tube of the N hollow cylindrical battery cells. The N ports include walls extending transverse to the first fluid channel and including threads on an outer surface thereof. An inner surface of the side wall of the hollow center tube of the N hollow cylindrical battery cells is threaded.

In other features, the hollow center tube passes through the top surface and the bottom surface of the enclosure. The battery heat exchange system includes a second fluid channel configured to at least one of supply fluid to and receive fluid from an opposite end of the hollow center tube of the N hollow cylindrical battery cells.

In other features, one of the first fluid channel includes N partitions in the N ports, respectively, and each of the N hollow cylindrical battery cells include a partition arranged in the hollow center tube.

A method for manufacturing a hollow battery cell includes double backwards extruding an enclosure for the hollow battery cell including a top surface, a side wall, a bottom surface, and a hollow center tube extending from the bottom surface and including a side wall and a cavity arranged between the side wall; winding a roll including electrode and separator layers; inserting the roll into the enclosure between the hollow center tube and the side wall of the enclosure; and attaching a top cap to the side wall and the hollow center tube on the top surface.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a side view of an example of a cylindrical battery cell;

FIG. 1B is an enlarged top view of an example of electrodes and separators in the process of being wound around a center post of the cylindrical battery;

FIG. 1C is a perspective view of a positive terminal with vent holes arranged above a burst disk;

FIG. 2A is a perspective view of an example of a prismatic battery cell;

FIG. 2B is a perspective view of an example of rolled electrodes arranged in the outer enclosure of the prismatic battery cell;

FIG. 2C is a perspective view of an example of terminals and tabs connected to electrodes of the prismatic battery cell;

FIG. 3A is a side view of an example of a hollow cylindrical battery cell with the hollow center tube that passes through an outer enclosure according to the present disclosure;

FIG. 3B is an enlarged top view of an example of rolled electrodes in the process of being wound around a hollow center tube of the cylindrical battery cell according to the present disclosure;

FIGS. 3C and 3D are top views of examples of top caps for the hollow cylindrical battery cell according to the present disclosure;

FIG. 3E is a perspective view of an example of a bottom cap of the hollow cylindrical battery cell according to the present disclosure;

FIG. 4A is a side view of an example of a hollow cylindrical battery cell with a hollow center tube that does not pass through the bottom surface of an outer enclosure according to the present disclosure;

FIG. 4B is an enlarged top view of an example of rolled electrodes in the process of being wound around a hollow center tube of the cylindrical battery cell;

FIG. 4C is a top view of an example of a top cap of the hollow cylindrical battery cell according to the present disclosure;

FIG. 5A is a side view of an example of a hollow prismatic battery cell with a hollow center tube that passes through an outer enclosure according to the present disclosure;

FIG. 5B is a top view of the hollow prismatic battery cell of FIG. 5A;

FIG. 5C is a bottom view of the hollow prismatic battery cell of FIG. 5A;

FIG. 6A is a side view of an example of a hollow prismatic battery cell with a hollow center tube that does not pass through the bottom surface of an outer enclosure according to the present disclosure;

FIG. 6B is a top view of the hollow prismatic battery cell of FIG. 6A;

FIG. 6C is a bottom view of the hollow prismatic battery cell of FIG. 6A;

FIG. 7 is a flowchart of an example of a method for manufacturing a hollow cylindrical battery cell according to the present disclosure;

FIG. 8 is a flowchart of another example of a method for manufacturing a hollow cylindrical battery cell according to the present disclosure;

FIGS. 9A to 9E are side cross sectional views illustrating examples of methods for manufacturing of an outer enclosure including a hollow center tube for a cylindrical battery cell according to the present disclosure;

FIGS. 10A to 10D are perspective views illustrating examples of methods for manufacturing a hollow cylindrical battery cell according to the present disclosure;

FIG. 11 is a flowchart of an example of a method for manufacturing a cylindrical battery cell according to the present disclosure;

FIGS. 12A to 12D are side cross sectional views of examples of heat exchange systems for hollow cylindrical battery cells according to the present disclosure;

FIGS. 12E to 12F are plan views of examples of heat exchange systems for an array of hollow cylindrical battery cells according to the present disclosure;

FIGS. 13A to 13B are side cross sectional views of examples of heat exchange systems for hollow prismatic battery cells according to the present disclosure; and

FIGS. 14A to 14C are side cross sectional views of examples of heat exchange systems for hollow cylindrical battery cells according to the present disclosure.

In the drawings, reference numbers may be reused to identify similar and/or identical elements.

### DETAILED DESCRIPTION

While hollow cylindrical and prismatic battery cells and heat exchange systems therefore are shown and described in the context of electric vehicles, the hollow cylindrical and prismatic battery cells and the heat exchange systems can be used in stationary applications and/or other applications.

Large format battery cells have high energy density and reduced manufacturing complexity/cost. However, as the size of the battery cells increase, it becomes more difficult to dissipate heat generated by the battery cells. When there is insufficient battery cooling, fast charging cannot be used with large format cells due to the high heat that is generated. While existing battery heat exchange systems can be used to heat and/or cool exposed surfaces of the battery cells (e.g., top, bottom and/or side surfaces of the battery cells), the center of the battery cell endures the highest temperatures during use.

The present disclosure relates to hollow battery cells including an outer enclosure and a hollow center tube. The outer enclosure can include a prismatic or cylindrical enclosure. In some examples, the hollow center tube has a circular cross section for cylindrical battery cells or a rounded rectangular cross section for prismatic battery cells. In some examples, the hollow center tube is arranged centrally relative to a center or center axis of the outer enclosure.

A roll of layers including one or more cathode electrodes, separators, and anode electrodes are wound around the hollow center tube. As will be described further below, a top cap and/or a bottom cap enclose the top and/or bottom sides of the battery cell.

The present disclosure also relates to a heat exchange system for hollow battery cells. The heat exchange system includes fluid channels and ports that fluidly connect and extend into the hollow center tubes from one or both sides to cool and/or heat the hollow battery cell from the center. In some examples, the fluid includes air, gas, and/or liquid. Cooling may be performed in response to cycling of the battery cells. Heating may be performed to heat a battery cell to a desired operating temperature after a soak at a lower temperature such as freezing or below.

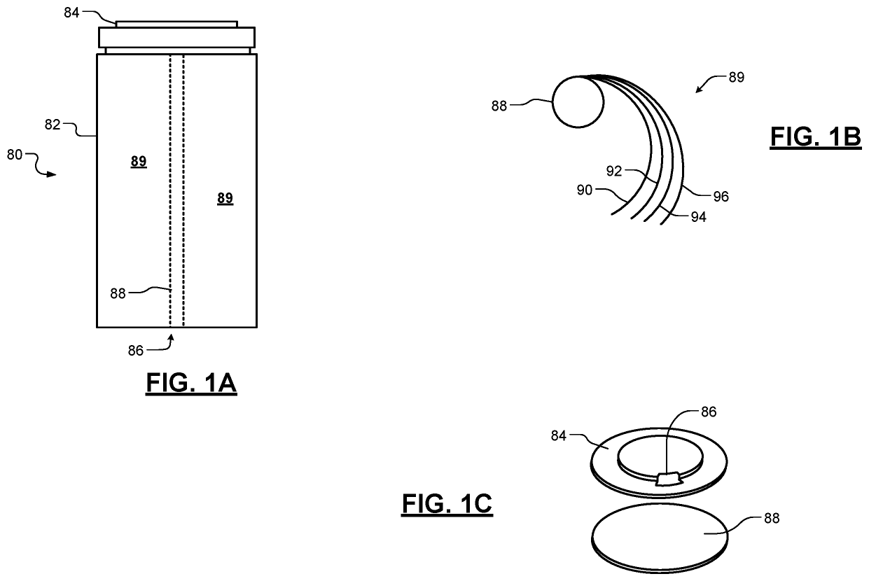

Referring now to FIGS. 1A to 1C, an example of a cylindrical battery cell 80 that is not hollow is shown. In FIG. 1A, the cylindrical battery cell 80 includes an outer enclosure 82, a positive terminal 84, and a negative terminal 86. A center post 88 extends vertically along a central axis of the outer enclosure 82. A roll 89 includes one or more anode electrodes, cathode electrodes, and separators wound around the center post 88. Given the small radius of the center post 88, there is a large bending force for thicker electrodes, which can make manufacturing difficult and/or reduce reliability.

In FIG. 1B, the roll 89 of layers is shown to include a cathode electrode 90, a separator 92, an anode electrode 94, and a separator 96. In some examples, the positive terminal 84 may include vents or holes and a burst disk (not shown) to allow gas to vent when pressure inside the outer enclosure is greater than a predetermined pressure.

In FIG. 1C, the cylindrical battery cell 80 may include a vent. For example, a positive terminal 84 may include one or more vent holes 86. A burst disk 88 may be arranged below the positive terminal 84. The burst disk 88 and the one or more vent holes 86 vent gas from the cylindrical battery cell 80 when pressure within the cylindrical battery cell 80 is greater than a predetermined pressure.

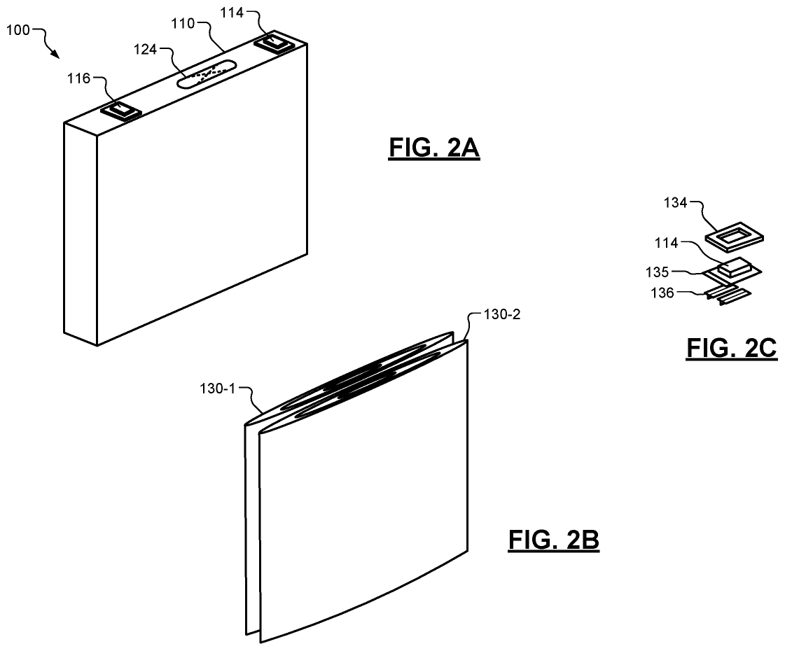

Referring now to FIGS. 2A to 2C, an example of a prismatic battery cell 100 is shown. In FIG. 2A, a prismatic battery cell 100 includes an enclosure 110. In some examples, the enclosure 110 has a rectangular cross-section. The prismatic battery cell 100 includes terminals 114 and 116 and a vent cap 124. In FIG. 2B, one or more rolls 130-1 and 130-2 including electrodes and separators are arranged side-by-side in the enclosure 110. For example, the rolls 130-1 and 130-2 may include the electrode and separator layers shown in FIG. 1B. The small winding diameter at ends of the rolls 130-1 and 130-2 requires a high bending force for thick electrodes, which can make manufacturing difficult and/or reduce reliability.

In FIG. 2C, the terminal 114 and a tab 135 are connected to tab connectors 136. The tab connectors 136 connect one polarity of the electrodes of the battery cell to the terminal 114. In some examples, a seal 134 is arranged between the terminal 114 and the enclosure 110.

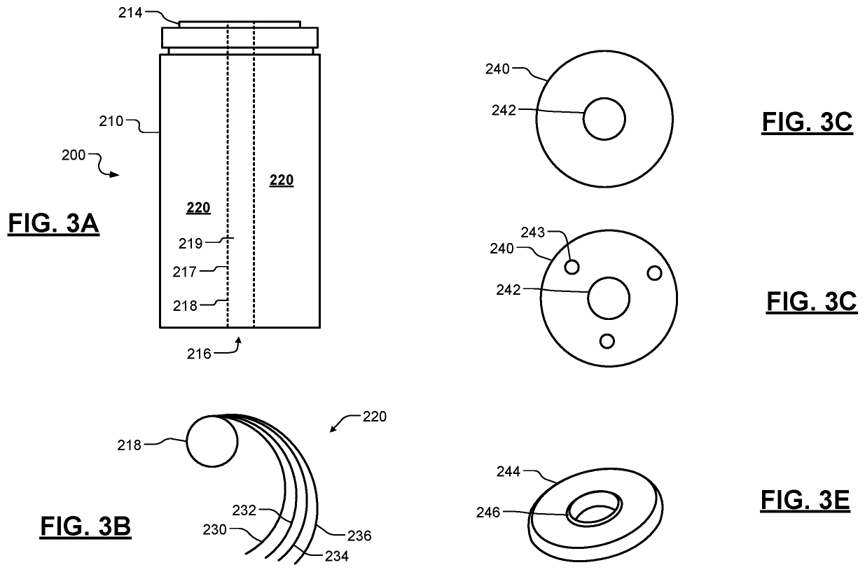

Referring now to FIGS. 3A to 3E, an example of a hollow cylindrical battery cell 200 with a center hole that passes through a bottom surface of an outer enclosure is shown. In FIG. 3A, the hollow cylindrical battery cell 200 includes an outer enclosure 210, a positive terminal 214 (or terminal 216), and a negative terminal 216. A hollow center tube 218 including an outer cylindrical wall 217 and an inner cavity 219 extends vertically along a central axis of the outer enclosure 210.

A roll 220 of layers is wound around the hollow center tube 218. The roll 220 of layers includes one or more anode electrodes, cathode electrodes, and separators. In FIG. 3B, the roll 220 is shown to include a cathode electrode 230, a separator 232, an anode electrode 234, and a separator 236. In FIG. 3C, a top cap 240 of the hollow cylindrical battery cell is shown to include a center through hole 242. In FIG. 3D, the top cap 240 may include one or more vent holes 243. A burst disk may be arranged below the top cap 240 as described above to vent gases when pressure within the cylindrical battery cell exceed a predetermined pressure. In FIG. 3E, a bottom cap 244 of the hollow cylindrical battery cell is shown to include a center through hole 246.

In some examples, the outer enclosure 210 has a height in a range from 60 mm to 120 mm (e.g., 80 mm or 100 mm). In some examples, the outer enclosure 210 has a diameter in a range from 40 mm to 60 mm (e.g., 46 mm).

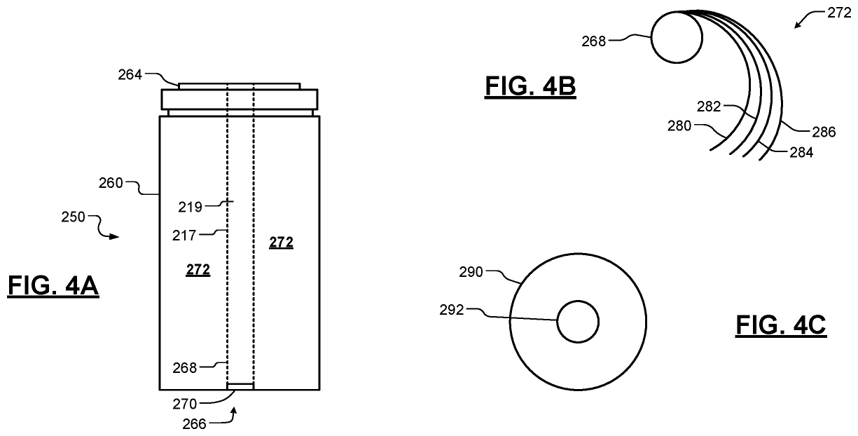

Referring now to FIGS. 4A to 4C, an example of a hollow cylindrical battery cell 250 with a center through hole that does not pass through a bottom surface of an outer enclosure is shown. In FIG. 4A, the hollow cylindrical battery cell 250 includes an outer enclosure 260, a positive terminal 264, and a negative terminal 266. A hollow center tube 268 extends vertically along a central axis of the outer enclosure 260. A bottom end of the hollow center tube 268 is closed. For example, the hollow center tube 268 may be welded to an inner side of a bottom surface of the outer enclosure 260, insulated from the bottom surface of the outer enclosure 260, and/or sealed as shown at 270. A roll 272 includes one or more anode electrodes, cathode electrodes, and/or separators wound around the hollow center tube 268.

In FIG. 4B, the roll 272 is shown to include a cathode electrode 280, a separator 282, an anode electrode 284, and a separator 286 that are wound around the hollow center tube 268. In FIG. 4C, a top cap 290 of the hollow cylindrical battery cell is shown to include a center through hole 292.

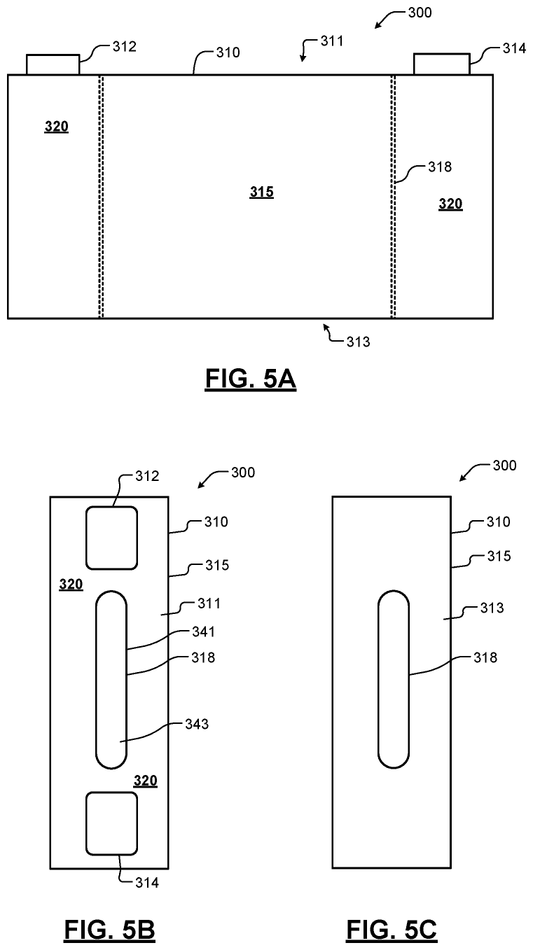

Referring now to FIGS. 5A to 5C, an example of a hollow prismatic battery cell 300 with a center through hole that passes through a bottom surface of an outer enclosure is shown. In FIG. 5A, the hollow prismatic battery cell 300 includes an enclosure 310. In some examples, the enclosure 310 has a rectangular shape and includes a top side 311, a bottom side 313, and side walls 315. The hollow prismatic battery cell 300 includes terminals 312 and 314 that are connected to the electrodes. The hollow prismatic battery cell 300 includes a hollow center tube 318 and a roll 320 including one or more electrodes and separators wound around the hollow center tube 318.

In FIG. 5B, the top side 311 of the hollow prismatic battery cell 300 is shown. In some examples, the hollow center tube 318 includes side walls 341, a cavity 343 defined between the side walls 341, an open top (FIG. 5B), and an open bottom (FIG. 5C). The hollow center tube 318 has a rounded rectangular cross section or an elongated elliptical cross section that extends in a vertical direction.

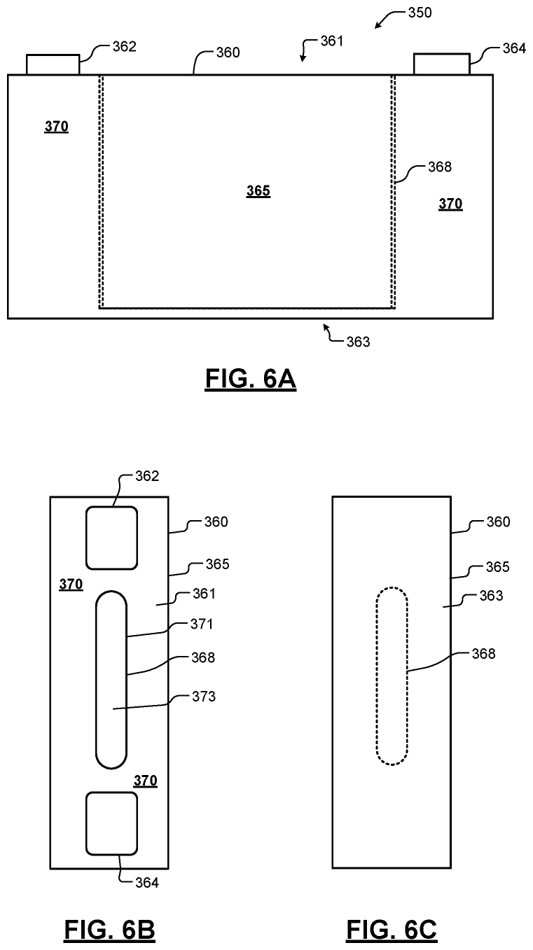

Referring now to FIGS. 6A to 6C, an example of a hollow prismatic battery cell 350 with a center through hole that does not pass through a bottom surface of an outer enclosure is shown. In FIG. 6A, the hollow prismatic battery cell 350 includes an outer enclosure 360. In some examples, the outer enclosure 360 has a rectangular shape and includes a top side 361, a bottom side 363, and side walls 365. The hollow prismatic battery cell 350 includes terminals 362 and 364 connected to the electrodes. The hollow prismatic battery cell 350 includes a hollow center tube 368 and a roll 370 including one or more electrodes and separators wound around the hollow center tube 368.

In FIG. 6B, the top side 361 of the hollow prismatic battery cell 350 is shown. In some examples, the hollow center tube 368 includes walls 371, a cavity 373 defined between the walls, an open top (FIG. 6B), and a closed bottom (FIG. 6C). The hollow center portion 318 has a rounded rectangular cross section or an elongated elliptical cross section that extends in a vertical direction.

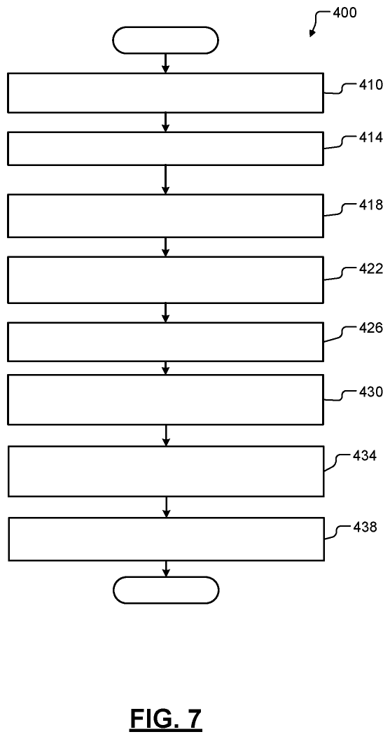

Referring now to FIG. 7, an example of a method 400 for manufacturing a hollow cylindrical battery cell is shown. At 410, the outer enclosure of the battery cell is stamped or extruded with an open top and a closed bottom. At 414, a hollow center tube is stamped or extruded.

At 418, a hole is punched, drilled or laser cut in the bottom surface of the outer enclosure. At 422, a roll of layers including one or more electrodes and separators are wound around the hollow center tube. At 426, the hollow center tube and the roll of layers are inserted into the outer enclosure. In some examples, one or both ends of the hollow center tube extend beyond corresponding end(s) of the outer enclosure. In some examples, the hollow center tube passes through the hole in the bottom surface of the outer enclosure. In some examples, the hollow center tube passes through the hole in the top cap (when the top cap is arranged on the top side).

At 430, the hollow center tube at the bottom of the outer enclosure is flanged outwardly to overlap edges of the hole in the bottom surface of the outer enclosure and the end of the hollow center tube is attached or sealed to the bottom surface. In other examples, a butt joint is created between the hollow center tube and the bottom surface. At 434, a top cap is arranged over the top of the outer enclosure and is attached (e.g., laser welded or attached to the outer enclosure and the hollow center tube using another method) at 438.

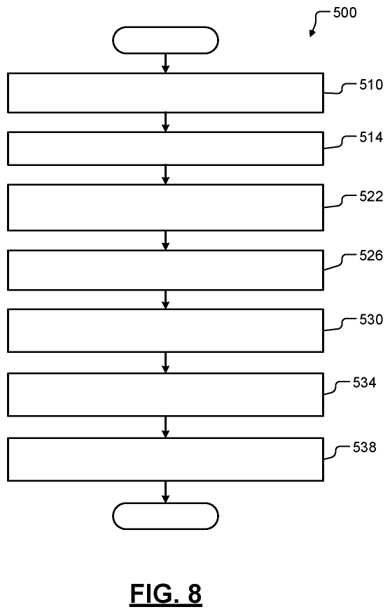

Referring now to FIG. 8, a method 500 for manufacturing a hollow cylindrical battery cell is shown. At 510, the outer enclosure of the battery cell is stamped or extruded with an open top and a closed bottom. At 514, a hollow center tube is stamped or extruded with an open or closed bottom surface. At 522, a roll of layers including electrodes and separators is wound around the hollow center tube.

At 526, an inner enclosure (including the hollow center tube and the wound layers) are inserted into the outer enclosure. At 530, the hollow center tube is attached (e.g., laser sealed) to an inner side of the bottom surface of the outer enclosure. At 534, a hole is optionally punched, drilled or laser cut in the bottom surface and/or the center tube. At 538, a top cap is attached (e.g., laser welded or attached using another method).

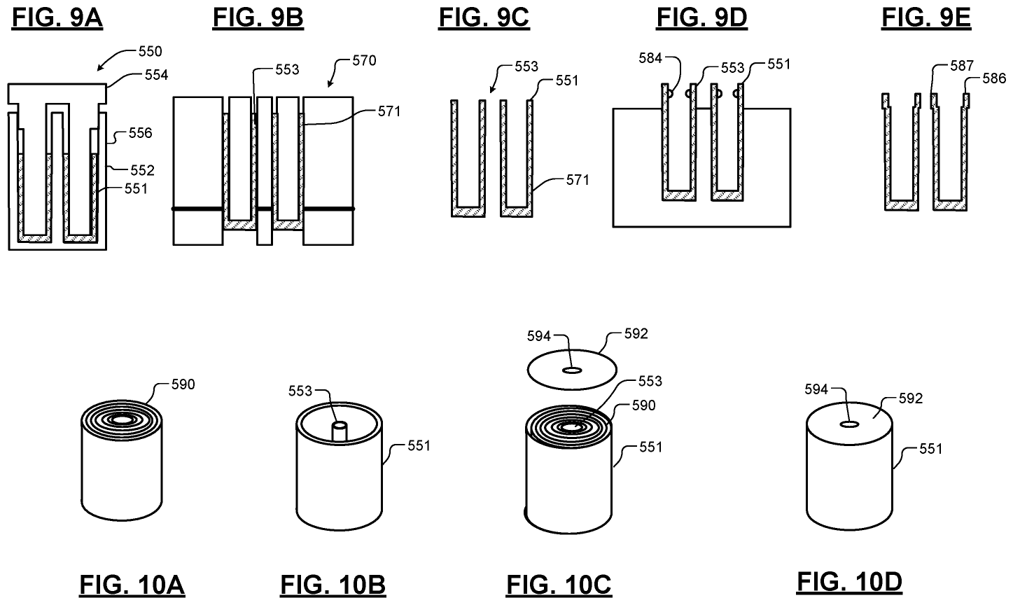

Referring now to FIGS. 9A to 9E, another method for manufacturing an outer enclosure including a center tube for a hollow cylindrical battery cell is shown. In FIG. 9A, an extrusion tool 550 including a female tool 552 and a male tool 554 are forced together by a press or other device to extrude an outer enclosure 551 with a hollow center tube 553. In some examples, double backward extrusion is performed with or without heating.

One or more additional forming steps may be performed as shown in FIGS. 9B to 9E. In FIG. 9B, an ironing tool 570 may be used to improve the quality of the outer enclosure 551 and/or the hollow center tube 553 (e.g., by straightening side walls 571). In FIG. 9C, trimming of the outer enclosure 551 is optionally performed. In FIGS. 9D and 9E, a forming tool 584 is used to form steps or edges 586 on the outer enclosure 551 and/or the hollow center tube 553 to interface with and/or provide clearance for a top and/or bottom cap prior to attaching the top and/or bottom cap and prevent it from falling through.

In this example, the hollow battery cell enclosure is manufactured as a unibody component, which eliminates the need to weld the hollow center tube to the outer enclosure. Further processing allows steps and flanges to be formed for the top cap. The bottom of the hollow center tube can be left open for hollow battery cells with through holes. Alternately, the bottom of the hollow center tube can be covered for hollow battery cells with non-through holes.

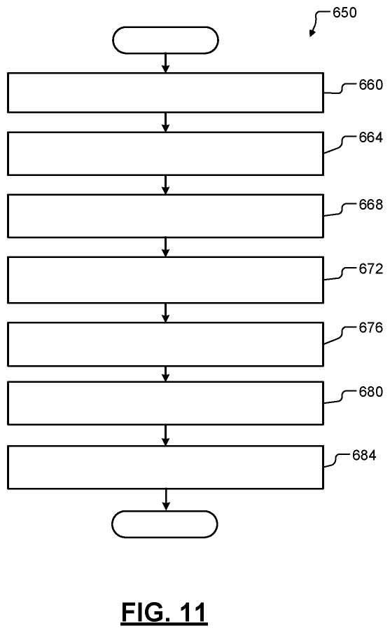

Referring now to FIGS. 10A to 10D, assembly of the hollow cylindrical battery cell using the outer enclosure of FIGS. 9A to 9E is shown. In FIG. 10A, a roll 590 including electrodes and separators is wound. In FIGS. 10B and 10C, the roll 590 of layers is inserted around the hollow center tube 553 in the outer enclosure 551. A top cap 592 including a through hole 594 is attached (e.g., using welding, a butt joint, or other joining method) to enclose a top of the battery cell as shown in FIG. 10D.

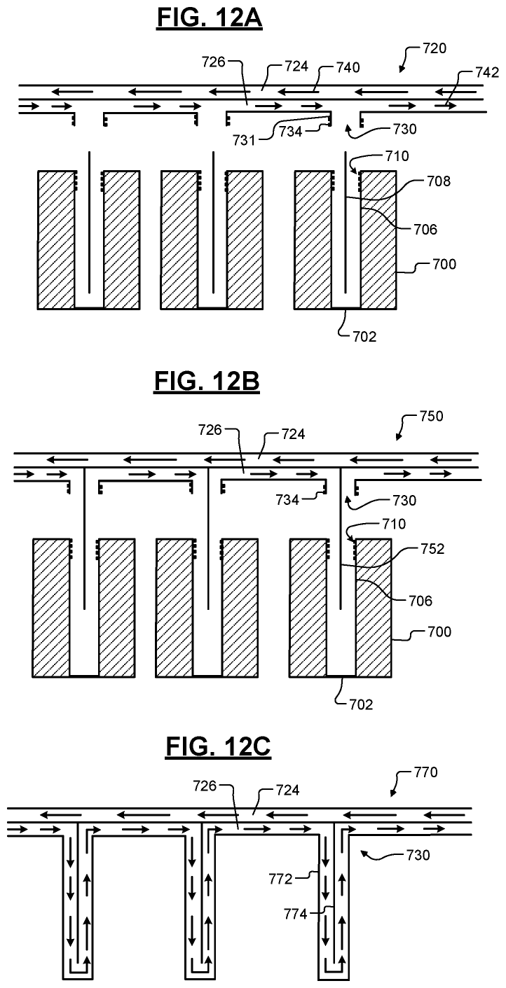

Referring now to FIG. 11, a method 650 for manufacturing a cylindrical battery cell is shown. At 660, the outer enclosure is extruded with an integrated hollow center tube. At 664, ironing of the outer enclosure is optionally performed using an ironing tool to straighten sides walls of the outer enclosure. At 668, trimming of the outer enclosure is optionally performed. At 672, a roll electrode and separator layers is wound. At 676, the roll is inserted in the outer enclosure between the hollow center tube and walls of the outer enclosure. At 680, a top cap including a hole is arranged on the outer enclosure and attached at 684 (e.g., using welding, a butt joint, or other joining method) to enclose a top of the battery cell.

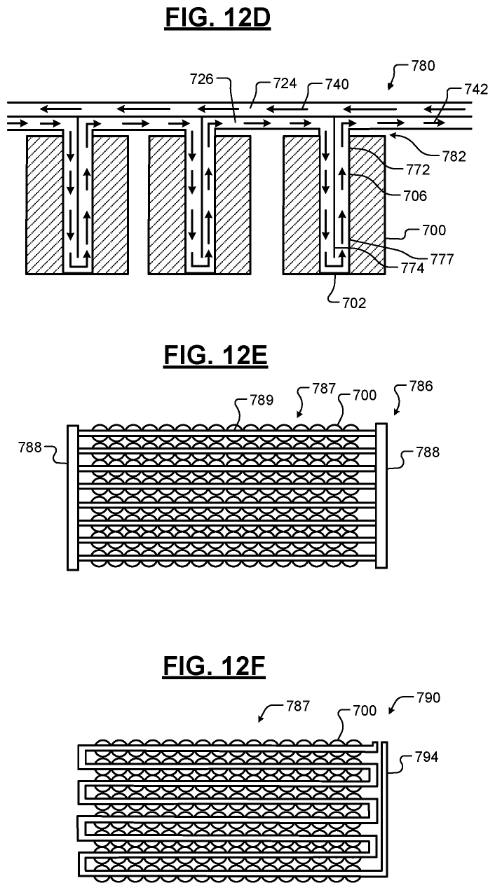

Referring now to FIGS. 12A and 12D, various examples of heat exchange systems for hollow cylindrical battery cells are shown. In FIG. 12A, a heat exchange system 720 includes a first fluid channel 724 and a second fluid channel 726 that are in a heat exchange relationship with one another and/or with the atmosphere. In other words, outer surface areas of the first fluid channel 724 and the second fluid channel 726 are in contact with each other and/or air.

In some examples, liquid is supplied by a pump from a liquid source to the fluid channels to perform cooling. After passing through the fluid channels and absorbing heat, the liquid optionally passes through a heat exchanger such as a radiator with fins for cooling and then the liquid is returned to the source. In some examples, liquid is supplied by a pump from a liquid source to a heater and then to the fluid channels to perform heating. After passing through the fluid channels and supplying heat, the liquid is returned to the source.

The second fluid channel 726 includes ports 730 that extend transversely from the second fluid channel 726 and that are connected to hollow center tubes 706 of battery cells 700. In some examples, the hollow center tubes 706 and the ports 730 include walls 731 with threaded portions at 710 and 734, respectively. In other examples, the walls 731 of the ports 730 do not include threads and are press fit into the hollow center tubes 706.

In some examples, the hollow center tubes 706 of the battery cells 700 are enclosed at 702 (at the bottom surface of the battery cells 700). In some examples, the battery cells 700 include partitions 708 configured to partition the hollow center tubes 706. In some examples, fluid 740 flows in the first fluid channel 724 in a first direction. Fluid 742 flows in the second fluid channel 726 in a second direction that is different than the first direction. Fluid 742 flows through the second fluid channel 726, through the ports 730, between the partition 708 and an inner surface of one side of the hollow center tube 706 of the battery cell 700, around an end of the partition 708, and between the partition 708 and an inner surface on the other side surface of the hollow center tube of the battery cell 700 back to the port 730.

In FIG. 12B, a heat exchange system 750 is similar to the heat exchange system 720 except that a partition 752 is connected to the heat exchange system 750 (e.g., at centers of the ports 730) rather than in the hollow center tube 706 of the battery cells 700.

In FIG. 12C, a heat exchange system 770 is self-contained and does not incorporate the inner surfaces of the battery cells. The heat exchange system 770 includes side walls 772 enclosing distal ends of the ports 730 and a partition 774 connected transverse to the second fluid channel 726. In some examples, the side walls 772 contact and form a tight fit with the walls of the hollow center tube 706 of the battery cells 700 to enhance heat exchange between the surfaces. In other examples, a thermal interface material or thermal adhesive (identified at 777 in FIG. 12D) is arranged between the side walls 772 and the hollow center tube 706.

In the examples in FIGS. 12A to 12C, the heat exchange systems contact top and/or bottom surfaces of the battery cells. In FIG. 12D, a heat exchange system 780 may define a gap 782 between top surfaces of the battery cells 700 and the heat exchange system 780. Since most of the cooling is performed along inner surfaces of the battery cells 700, the gap 782 may be used.

Referring now to FIG. 12E, a heat exchange system 786 is shown for an array 787 of the battery cells 700. Manifolds 788 are arranged on opposite sides of the array 787 and channels 789 extend from side to side along each row between the manifolds 788. As can be appreciated, the channels 789 can extend along columns of the array 787. Connections to the positive or negative terminals of the battery cells can be made in off center locations.

Referring now to FIG. 12F, a heat exchange system 790 is shown for the array 787 of the battery cells 700. One or more fluid channels 794 extend in a zig-zag pattern each covering more than one row of the array 787. As can be appreciated, other arrangements of the fluid channels can be used.

In some examples, the fluid channels of the heat exchange system are made of a material selected from a group consisting of aluminum alloy and copper. In some examples, the fluid comprises liquid, gas, or air. If the fluid channel includes multiple channels, a partition may be arranged in the fluid channel or the hollow center tube to divide the fluid channel. The partition can be made of a material selected from a group consisting of metal, polymer, and/or plastic. In some examples, the heat exchange system is self-enclosed. In other examples, the heat exchange system uses walls in the hollow center core and fluid directly contacts the walls of the hollow center core.

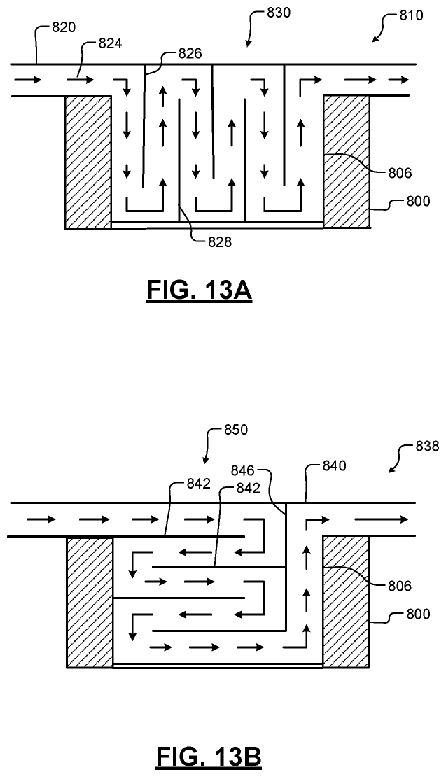

Referring now to FIGS. 13A to 13B, other examples of heat exchange systems for hollow prismatic battery cells are shown. In FIG. 13A, heat exchange system 810 includes a fluid channel 820 that extends into a hollow center 806 of a prismatic battery cell 800 and around vertical partitions 826 and 828 to define a vertical zig-zag pattern 830. In FIG. 13B, heat exchange system 838 includes a fluid channel 840 that extends into a hollow center 806 of the prismatic battery cell 800 and around horizontal partitions 842 and one or more vertical partitions 846 to define a horizontal zig-zag pattern 850.

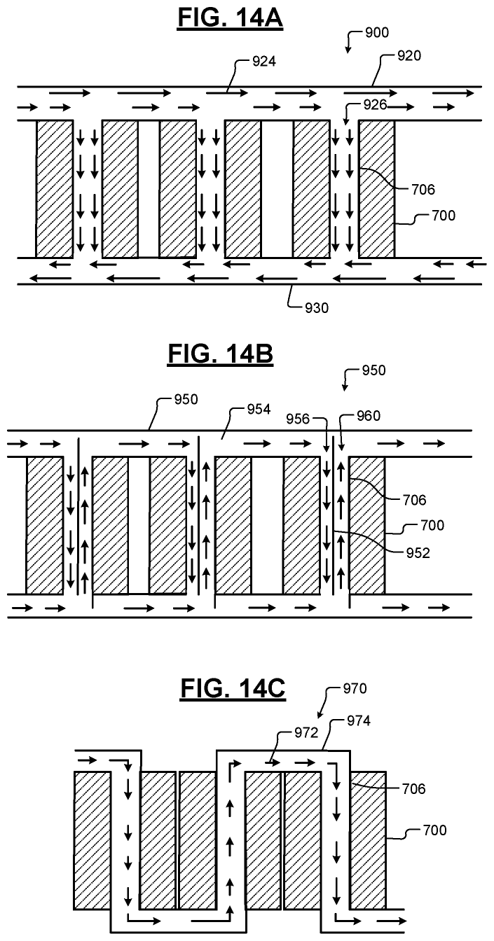

Referring now to FIGS. 14A to 14C, for hollow battery cells with through holes, the fluid channels can be arranged on both sides of the battery cells. In FIG. 14A, a heat exchange system 900 includes horizontal fluid channels 920 and 930 arranged on opposite sides of the battery cells 700. Fluid 924 flows in the horizontal fluid channels 920, through vertical channels 926 through the hollow center tube 706 of the battery cells 700 to the horizontal fluid channel 930. In some examples, the horizontal fluid channels 920 and 930 flow in opposite directions.

In FIG. 14B, a heat exchange system 950 includes horizontal fluid channels 920 and 930 arranged on opposite sides of the battery cells 700. Vertical partitions 952 are arranged in the hollow center tube 706 of the battery cells 700. The vertical partitions 952 extend into the horizontal fluid channels 920 and 930 and define a gap with an inner wall of the horizontal fluid channels 920 and 930.

Fluid 924 flows in the horizontal fluid channels 920, downwardly through vertical channels 956 on one side of the vertical partition 952 through the hollow center tube 706 of the battery cells 700 to the horizontal fluid channel 930. The fluid 924 flows in the horizontal fluid channel 930, upwardly through a vertical channel 960 on the other side of the vertical partition 952 through the hollow center tube 706 of the battery cells 700 to the horizontal fluid channel 920. In some examples, the horizontal fluid channels 920 and 930 supply the fluid 924 in the same direction (e.g., from left to right in FIG. 14B).

In FIG. 14C, a heat exchange system 970 includes a fluid channel 974 (e.g., a single fluid channel) that extends through the hollow center tubes 706 of multiple adjacent battery cells 700. In other words, the fluid channel 974 alternately extends upwardly through a hollow center tube of a first battery cell and across top surfaces of the first battery cell and a second battery cell, and then downwardly through the hollow center tube of the second battery cell and across a bottom surface of the second battery cell to another battery cell and so on. The battery cells can be arranged in a row or in rows and columns as shown in FIG. 12F.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery system, comprising:
N hollow battery cells, each including:
an enclosure including a top surface, a bottom surface, and a side wall;
a hollow center tube including a side wall and a cavity enclosed by the side wall,
wherein the hollow center tube passes through at least one of the top surface and the bottom surface of the enclosure; and
a roll including electrode and separator layers arranged between an outer surface of the hollow center tube and the enclosure; and
a battery heat exchange system including a first fluid channel including N ports configured to at least one of supply fluid to and receive fluid from at least one end of the hollow center tube of the N hollow battery cells.

2. The battery system of claim 1, wherein:
the enclosure has a cylindrical shape; and
the hollow center tube has a circular cross section.

3. The battery system of claim 2, wherein the hollow center tube passes through the top surface and the bottom surface of the enclosure.

4. The battery system of claim 3, wherein the battery heat exchange system includes a second fluid channel configured to at least one of supply fluid to and receive fluid from an opposite end of the hollow center tube of the N hollow battery cells.

5. The battery system of claim 1, wherein at least one of the top surface and the bottom surface comprises a cap attached to the side wall of the enclosure and the hollow center tube.

6. The battery system of claim 1, wherein:
the enclosure has a prismatic shape, and
the hollow center tube has a rounded rectangular cross section.

7. The battery system of claim 6, wherein the hollow center tube passes through the top surface and the bottom surface of the enclosure.

8. The battery system of claim 7, wherein the battery heat exchange system includes a second fluid channel configured to at least one of supply fluid to and receive fluid from an opposite end of the hollow center tube of the N hollow battery cells.

9. The battery system of claim 6, wherein the first fluid channel includes a plurality of partitions to create a serpentine vertical path in the hollow center tube.

10. The battery system of claim 6, wherein the first fluid channel includes a plurality of partitions to create a serpentine horizontal path in the hollow center tube.

11. The battery system of claim 2, wherein:
the N ports include N walls extending transverse to the first fluid channel and including threads on an outer surface thereof; and
an inner surface of the side wall of the hollow center tube of the N hollow battery cells includes threads.

12. The battery system of claim 1, wherein the first fluid channel includes N partitions in the N ports, respectively.

13. The battery system of claim 1, wherein each of the N hollow battery cells include a partition arranged in the hollow center tube.

14. The battery system of claim 1, further comprising a second fluid channel arranged adjacent and in contact with the first fluid channel, wherein fluid flows in a first direction through the first fluid channel and in a second direction through the second fluid channel.

15. The battery system of claim 3, wherein the first fluid channel extends in a serpentine path upwardly and downwardly through the hollow center tubes of adjacent ones of the N hollow battery cells.

16. The battery system of claim 2, wherein:
the N ports include N walls extending transverse to the first fluid channel; and
the N walls are press fit into an inner surface of the side wall of the hollow center tube of the N hollow battery cells.

17. A battery system, comprising:
N hollow cylindrical battery cells, each including:
an enclosure including a top surface, a bottom surface, and side walls;
a hollow center tube including a side wall defining a cavity and having a circular cross section,
wherein the hollow center tube passes through at least one of the top surface and the bottom surface of the enclosure; and
a roll including electrode and separator layers arranged between an outer surface of the hollow center tube and the enclosure; and
a battery heat exchange system including a first fluid channel including N ports configured to at least one of supply fluid to and receive fluid from at least one end of the hollow center tube of the N hollow cylindrical battery cells,
wherein the N ports include N walls extending transverse to the first fluid channel, respectively; and
wherein one of:
the N walls include threads on an outer surface thereof and an inner surface of the side wall of the hollow center tube of the N hollow cylindrical battery cells is threaded; and
the N walls are press fit into an inner surface of the side wall of the hollow center tube of the N hollow cylindrical battery cells.

18. The battery system of claim 17, wherein:
the hollow center tube passes through the top surface and the bottom surface of the enclosure; and
the battery heat exchange system includes a second fluid channel configured to at least one of supply fluid to and receive fluid from an opposite end of the hollow center tube of the N hollow cylindrical battery cells.

19. The battery system of claim 17, wherein one of:
the first fluid channel includes N partitions in the N ports, respectively, and
each of the N hollow cylindrical battery cells include a partition arranged in the hollow center tube.

20. A method for manufacturing a hollow battery cell, comprising:
double backwards extruding an enclosure for the hollow battery cell including a top surface, a side wall, a bottom surface, and a hollow center tube extending from the bottom surface and including a side wall and a cavity arranged between the side wall;
winding a roll including electrode and separator layers;
inserting the roll into the enclosure between the hollow center tube and the side wall of the enclosure; and
attaching a top cap to the side wall and the hollow center tube on the top surface.
